(19) United States
(12) Patent Application Publication
(10) Pub. No.: US 2008/0036975 A1
(43) Pub. Date: Feb. 14, 2008

(54) PROJECTOR AND TEMPERATURE CONTROL METHOD USED IN THE PROJECTOR

(75) Inventors: Jing Yang, Shenzhen City (CN); Xiao-Guang Li, Shenzhen City (CN); Kuan-Hong Hsieh, Shenzhen City (CN); Bing Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/773,954

(22) Filed: Jul. 5, 2007

(30) Foreign Application Priority Data
Aug. 11, 2006 (CN) 200610062077.7

(51) Int. Cl. G03B 21/16

(52) U.S. Cl. 353/57

(57) ABSTRACT

A temperature control method adapted for a projector is provided. The projector includes a power supply unit, a battery, a cooling fan, a temperature detection unit, and a power management unit. The method includes: (a) switching power supply from the power supply unit to the battery, thereby maintaining a normal operation of the cooling fan and the temperature detection unit, when detecting a power outage of the power supply unit; (b) detecting a temperature of the projector; and (c) stopping supplying power to the projector, when the detected temperature of the projector reaches a predetermined value. Related projectors using the method are also provided.

### BACKGROUND

1. Technical Field

The present invention relates to projectors, and particularly to a projector with a temperature control function and a method for controlling inside temperature of the projector.

2. General Background

A projector contains many components that generate heat. For example, the component can be a light source device, a printed circuit board assembly, or a power supply system. This leads to a high temperature inside the projector. The high temperature may cause the components inside the projector to over heat and become damaged. Accordingly, it is important to cool the projector.

It is well known that providing a cooling fan inside the projector can dissipate the heat out of the projector. Even after use, the projector must continue to control the cooling fan until the components are at a safe temperature. Sometimes a long cool down time is needed before the projector is cooled down. This long cool-down time may be inconvenient and cumbersome.

Furthermore, when a sudden power outage occurs, the cooling fan, along with the components, would be powered off, and the residual heat of the components would not be able to dissipate quickly. As a consequence, the temperature inside the projector may rise to a level that can damage the components inside the projector and shorten their useful service life, compared to properly using the cooling fan until the components are sufficiently cooled.

Therefore, what is needed, is a projector which can dissipate excess heat even after losing power from the mains power supply.

### SUMMARY

A projector with a battery is provided. The projector includes a power supply unit, a battery, a cooling fan, a temperature detection unit, and a power management unit. The temperature detection unit is configured for detecting the inside temperature of the projector. The power management unit is electrically coupled to the power supply unit, the battery, the cooling fan, and the temperature detection unit. When detecting that the power supply unit is not supplying power, the power management unit switches to the battery, thereby maintaining a normal operation of the cooling fan and the temperature detection unit. When the detected temperature reaches a predetermined value, the temperature detection unit sends a halt command to the power management unit, and in response to this halt signal the power management unit switches off power, from the power supply unit or the battery, to the cooling fan.

A temperature control method adapted for a projector is also provided. The projector includes a power supply unit, a battery, a cooling fan, a temperature detection unit, and a power management unit. The method includes: (a) switching power supply from the power supply unit to the battery, thereby maintaining a normal operation of the cooling fan and the temperature detection unit, when detecting a power outage of the power supply unit; (b) detecting a temperature of the projector; and (c) stop supplying power to the projector when the detected temperature of the projector reaches a predetermined value.

Other advantages and novel features will be drawn from the following detailed description with reference to the attached drawing.

### BRIEF DESCRIPTION OF THE DRAWINGS

FIG. 1 is a block diagram of a hardware infrastructure of a projector in accordance with a preferred embodiment of the present invention;

FIG. 2 is a flowchart of a preferred temperature control method used in the projector of FIG. 1, in accordance with the present invention; and

FIG. 3 is a block diagram of a hardware infrastructure of a projector in accordance with an alternative embodiment of the present invention.

### DETAILED DESCRIPTION OF THE EMBODIMENT

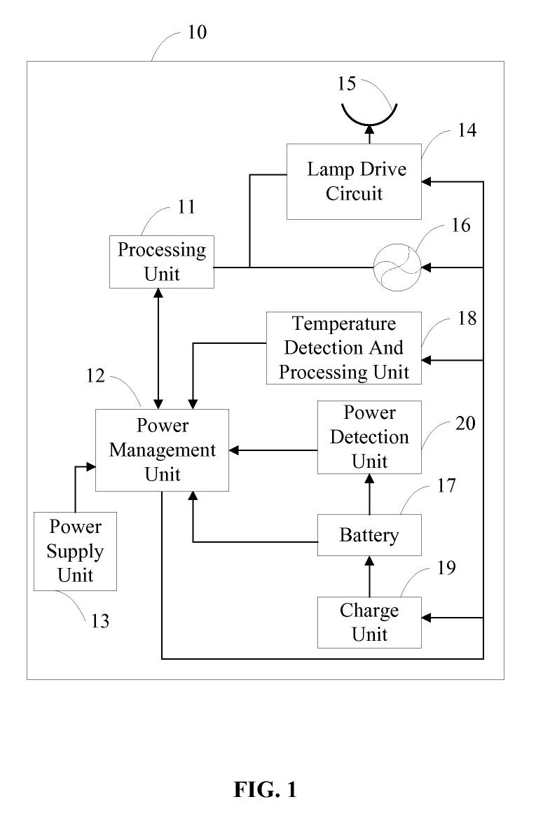

FIG. 1 is a schematic diagram of a hardware infrastructure of a projector in accordance with a preferred embodiment of the present invention. The projector 10 includes a processing unit 11, a power management unit 12, a power supply unit 13, a lamp drive unit 14, a lamp 15, a cooling fan 16, a backup battery 17, and a temperature detection and processing unit 18. The power supply unit 13 is configured for converting high voltage AC mains electricity to a suitable low voltage supply for electronic components of the projector 10. The battery 17 is configured for supplying power when a power outage of the power supply unit 13 occurs, namely where the high voltage AC mains electricity is prematurely cut-off/discontinued before an internal temperature of the projector 10 is cooled to a predetermined value.

The processing unit 11 is configured for controlling the power management unit 12 to supply appropriate power to the lamp drive unit 14, the cooling fan 16, and the temperature detection and processing unit 18.

The power management unit 12 is electrically coupled to the processing unit 11, the power supply unit 13, the lamp drive unit 14, the cooling fan 16, the battery 17, and the temperature detection and processing unit 18. The power management unit 12 is configured for controlling power received from the power supply unit 13 or the battery 17 to the processing unit 11, the lamp drive unit 14, the cooling fan 16, and the temperature detection and processing unit 18.

In a normal state, the power management unit 12 controls the power supply unit 13 to supply power to the processing unit 11, the lamp drive unit 14, the cooling fan 16, and the temperature detection and processing unit 18. The power management unit 12 further continuously detects whether the power outage of the power supply unit 13 occurs, that is the power management unit 12 detects whether power from the power supply unit 13 is suddenly discontinued prematurely. When it is detected the power outage of the power supply unit 13, the projector 10 is in an abnormal state. In the abnormal state, the power management unit 12 switches to the battery 17, thereby maintaining a normal operation of the processing unit 11, the cooling fan 16, and the temperature detection and processing unit 18. Thus, even when there is no power from the power supply unit 13, the projector 10 is still able to dissipate residual heat, of the components, inside of the projector 10 thereby reducing the temperature of the projector 10.

The lamp 15 is used as a light source and is driven by the lamp drive unit 14. The cooling fan 16 is configured for dissipating heat inside of the projector 10, thereby preventing the components of the projector 10 from damage caused by high temperature. The temperature detection and processing unit 18 is configured for detecting a temperature of the projector 10 and for generating a halt command to the power management unit 12 when the detected temperature reaches a predetermined value. The power management unit 12 controls the power supply unit 13 or the battery 17 to discontinue supplying power to the cooling fan 16 and the temperature detection unit, according to the halt command.

In addition, when the battery 17 is a rechargeable battery, the projector 10 can further include a charge unit 19 and a power detection unit 20. The power detection unit 20 is configured for detecting a remaining charge of the rechargeable battery 17. When the remaining charge reaches a first predetermined level, namely where the rechargeable battery 17 needs to be charged, the power detection unit 20 power outage a charging command to the power management unit 12. The power management unit 12 controls the charge unit 19 to charge the rechargeable battery 17 according to the charging command. When the remaining charge reaches a second predetermined level, namely where the rechargeable battery 17 has been full charged, the power detection unit 20 power outage a stop-charging command to the power management unit 12. The power management unit 12 controls the charge unit 19 to stop charging the rechargeable battery 17 according to the stop-charging command.

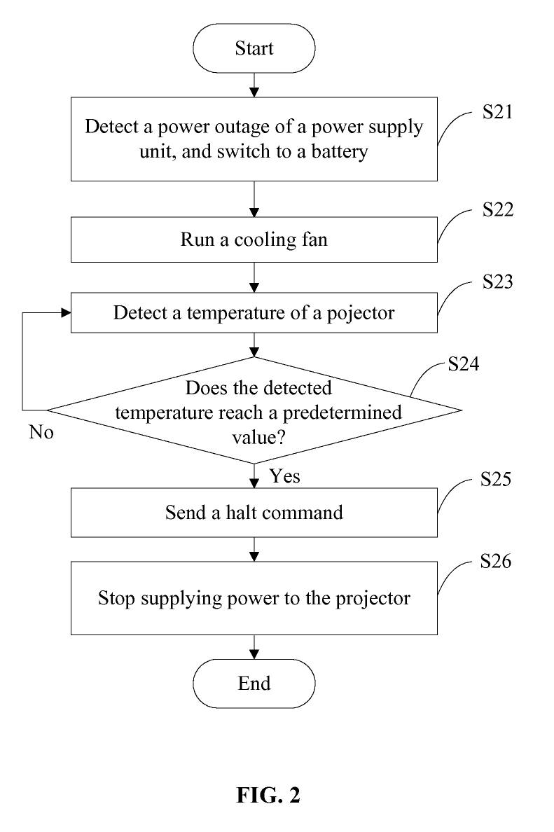

Referring to FIG. 2, a preferred temperature control method adapted for the projector 10 is provided.

In step S21, the power management unit 12 detects the power outage of the power supply unit 13, and switches to the battery 17, thereby maintaining the normal operation of the cooling fan 16 and the temperature detection and processing unit 18.

In step S22, the cooling fan 16 continues running.

In step S23, the temperature detection unit 20 detects the temperature of the projector 10.

In step S24, the temperature detection unit 20 determines whether the detected temperature reaches the predetermined value. If the detected temperature does not reach the predetermined value, the procedure returns to step S23.

If the detected temperature reaches the predetermined value, in step S25, the temperature detection unit 20 power outage the halt command to the power management unit 12.

In step S26, the power management unit 12 controls the battery 17 to stopping supplying power to the cooling fan 16 and the temperature detection and processing unit 18, and the procedure is finished.

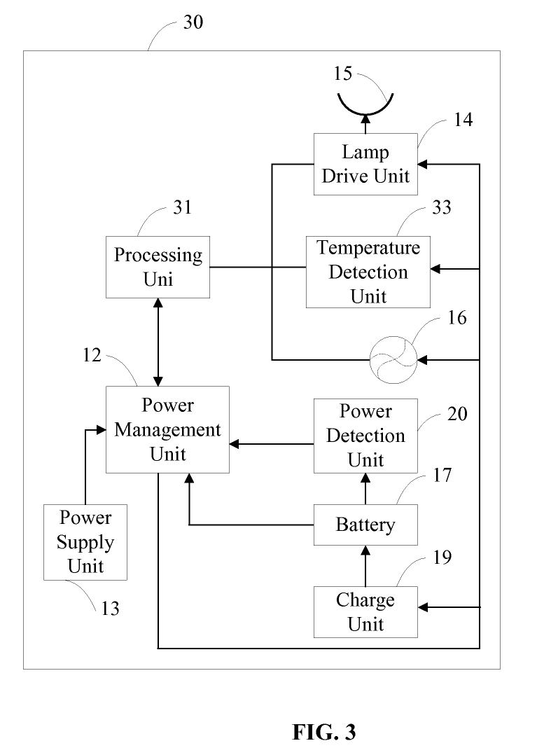

Reference is now made to FIG. 3, which illustrates an alternative embodiment of the present invention and is slightly different from the first embodiment, wherein like components bear the same reference numerals and will not be described again if they perform the same function or behavior.

In the alternative embodiment, the temperature detection unit 33 detects the temperature of the projector 30 and transmits the detected temperature to the processing unit 31. The processing unit 31, includes all the functionality of the processing unit 11 and also some of the functionality of the “Temperature Detection And Processing Unit 18” shown in FIG. 1. The processing unit 31 determines whether the detected temperature reaches the predetermined value. If the detected temperature reaches the predetermined value, the processing unit 31 sends the halt command to the power management unit 12. If the detected temperature is not at the predetermined value, the processing unit 31 continues to monitor the detected temperature. The power management unit 12 controls the power supply unit 13 or the battery 17 to stop supplying power to the cooling fan 16 and the temperature detection unit 33.

Although the present invention has been specifically described on the basis of preferred embodiments including a preferred method thereof, the invention is not to be construed as being limited thereto. Various changes or modifications may be made to the embodiments including the method without departing from the scope and spirit of the invention.

What is claimed is:

1. A projector comprising:
a power supply unit;
a battery;
a cooling fan, configured for dissipating heat;
a temperature detection unit, configured for detecting temperature of the projector; and
a power management unit, electrically coupled to the power supply unit, the battery, the cooling fan, and the temperature detection unit;
wherein, when the power management unit detects a power outage of the power supply unit, the power management unit switches to the battery, thereby maintaining a normal operation of the cooling fan and the temperature detection unit; and
when the detected temperature reaches a predetermined value, the temperature detection unit power outage a halt command to the power management unit, and the power management unit controls the power supply unit or the battery to stop supplying power to the projector, according to the halt command.

2. The projector according to claim 1, further comprising a processing unit for controlling the power management unit to supply appropriate power to the cooling fan and the temperature detection unit respectively.

3. The projector according to claim 1, wherein the battery is a non-rechargeable battery.

4. The projector according to claim 1, wherein the battery is a rechargeable battery.

5. The projector according to claim 4, further comprising a power detection unit and a charge unit, wherein the power detection unit is configured for detecting remaining charge of the battery and for generating a charging command to the power management unit when the remaining charge reaches a predetermined level, and the power management unit control the charge unit to charging the battery according to the charging command.

6. A projector comprising:
a power supply unit;
a battery;
a cooling fan, configured for dissipating heat;
a temperature detection unit, configured for detecting temperature of the projector;
a processing unit, configured for receiving the detected temperature generated from the temperature detection unit, and for processing the detected temperature; and
a power management unit, electrically coupled to the power supply unit, the battery, the processing unit, the cooling fan, and the temperature detection unit;
wherein, when the power management unit detects a power outage of the power supply unit, the power management unit switches to the battery, thereby maintaining a normal operation of the processing unit, the cooling fan, and the temperature detection unit; and
when the processing unit determines that the detected temperature reaches a predetermined value, the processing unit sends a halt command to the power management unit, and the power management unit controls the power supply unit or the battery to stop supplying power to the projector, according to the halt command.

7. The projector according to claim 6, wherein the processing unit is further configured for controlling the power management unit to supply appropriate power to the cooling fan and the temperature detection unit respectively.

8. The projector according to claim 6, wherein the battery is a non-rechargeable battery.

9. The projector according to claim 6, wherein the battery is a rechargeable battery.

10. The projector according to claim 9, further comprising a power detection unit and a charge unit, wherein the power detection unit is configured for detecting remaining charge of the battery and for generating a charging command to the power management unit when the remaining charge reaches a predetermined level, and the power management unit control the charge unit to charging the battery according to the charging command.

11. A temperature control method adapted for a projector which comprises a power supply unit, a battery, a cooling fan, a temperature detection unit, and a power management unit, the method comprising:
switching power supply from the power supply unit to the battery, thereby maintaining a normal operation of the cooling fan and the temperature detection unit, when detecting a power outage of the power supply unit;
detecting a temperature of the projector; and
stopping supplying power to the projector, when the detected temperature of the projector reaches a predetermined value.
